(19) United States
(12) Patent Application Publication
(10) Pub. No.: US 2019/0150486 A1
(43) Pub. Date: May 23, 2019

(54) FOOD PROCESSING SYSTEM AND FOOD PRODUCT

(71) Applicant: HELLO DELICIOUS BRANDS LLC, NORTHBROOK, IL (US)

(72) Inventor: Andy SILVESTRI, Geneva, IL (US)

(73) Assignee: HELLO DELICIOUS BRANDS LLC, NORTHBROOK, IL (US)

(21) Appl. No.: 16/099,276

(22) PCT Filed: May 12, 2017
(86) PCT No.: PCT/US2017/032359

§ 371 Date: Nov. 6, 2018

Related U.S. Application Data
(60) Provisional application No. 62/335,960, filed on May 13, 2016.

(51) Int. Cl. A23L 7/126; A23L 7/191; A23P 30/20

(52) U.S. Cl. CPC A23L 7/126; A23V 2002/00; A23P 30/20; A23L 7/191

(57) ABSTRACT

An apparatus and method for creating a sheeted food product having a minimal thickness. The apparatus includes grooved feed rollers covered in a nonstick material which prevents the formation of obstructions, allowing a narrower gap for sheeting food product. The process includes mixing a binding agent and dry ingredients, confirming the binding agent has covered the majority of the dry ingredients, rapidly transferring the mixed binding agent and dry ingredients to an extruder, and extruding a sheeted food product having minimal thickness.

### FIELD OF THE INVENTION

The invention relates to a device and method for making sheeted products. More particularly, the invention relates to a device and process for preparing sheeted food products and, in particular, a product from caramel and popcorn.

### BACKGROUND OF THE INVENTION

Snack bars, treats and confectionary products have become increasingly popular in recent years. As society becomes more mobile, the need for healthy food-on-the-go alternatives has become increasingly important. To that end, a group of food snacks have been developed which are a combination of grains and/or flavoring ingredients, as well as binder materials which add consistency to the food snack. Example grains include granola, oats, barley, bulgur, flaxseed, quinoa, rye, rice and popped corn (popcorn), while example flavoring ingredients include dried fruits, nuts and chocolate products. Binder materials vary and can include syrups consisting of caramel, marshmallow, karo syrup, corn syrup and/or sugars.

The food snacks can be manufactured via multiple methods such as extrusion, slab forming and sheeting, among others. Manufacturing requirements include ensuring that the food constituents be kept in a malleable form capable of shape formation into a packable, storable, consumable solid. This is often achieved through mixing constituents of different physical form to provide an even mixture of adequate organoleptic properties to meet consumer tastes. Further manufacturing requirements include ensuring that the food product is shaped into a viable form that meets the taste, texture and/or mouthfeel tastes of the consumer.

In addition to the above organoleptic properties, there has been a long felt need for snack bars and like confectionaries which are well-formed and having a minimal thickness. While the prior art discloses that such thin-sized bars can be achieved when utilizing a homogenous mixture (see, for example, U.S. Pat. No. 5,505,978), there has been difficulty in forming stable, thin-form usable food stuff from a heterogeneous mixture, e.g., a granular solid with a semisolid or solid flavoring agent and liquid binding agent. For example, U.S. Pat. No. 6,200,611 discloses a method and apparatus for preparing a bar containing a heterogeneous mixture of popcorn and molten binder, yet the disclosed bar has a minimum thickness of ¾ inch. Similarly, U.S. Pat. No. 7,037,551 discloses methods of preparing bite-size granola bars via extrusion methods, yet discloses that the bars typically have a thickness of ½ inch.

It is believed that when trying to manufacture thin-sized bars containing heterogeneous mixtures problems have been experienced due to the naturally adhesive properties of binding agents. Specifically, such binding agents will adhere to the manufacturing apparatus, creating obstructions and impeding the flow of the product. Even if obstructions do not occur, the dry ingredients in heterogeneous mixture are not adequately covered by the binding agent, resulting in a product with inferior organoleptic properties.

Thus, a need exists for a sheeted bar or confectionary having a minimal thickness and containing heterogeneous constituents, yet still maintaining desirable organoleptic properties.

### SUMMARY OF THE INVENTION

Disclosed herein is a method of preparing a sheeted mixture comprising a binding agent and a dry ingredient, the method comprising the steps of heating said binding agent; mixing said dry ingredient with said binding agent to form a mixture; transferring said mixture to an extruder, wherein said extruder comprises feed rollers coated with a non-stick coating; extruding a sheet comprising said mixture; and cooling said sheet comprising said mixture, wherein said sheet comprising said mixture has a thickness of less than ½ inch.

Separately disclosed herein is an apparatus for extruding material comprising: a hopper; a housing containing feed rollers, said housing being in fluid communication with said hopper, wherein the exterior of said feed rollers and are coated with a non-stick coating; a conveyor in fluid communication with said housing; means to actuate said feed rollers and said conveyor; and means to control the rate of movement of said feed rollers, and said conveyor.

### BRIEF DESCRIPTION OF THE FIGURES

FIG. 1 is a side perspective view of one embodiment of the claimed invention;

FIG. 2 is a cut-through, side perspective view of a portion of one embodiment of the claimed invention, further depicting grooved feed roller wheels;

FIG. 3 is a back perspective view of one embodiment of the claimed invention;

FIG. 4 is a front perspective view of one embodiment of the claimed invention;

FIG. 5 is a top-perspective view of one embodiment of the claimed invention, further depicting a hopper and roller wheels;

FIG. 6 illustrates one embodiment of a controller for use in connection with the claimed invention.

FIG. 7 is a flow diagram of one embodiment of a process embodying features of the invention.

### DETAILED DESCRIPTION OF THE PREFERRED EMBODIMENTS

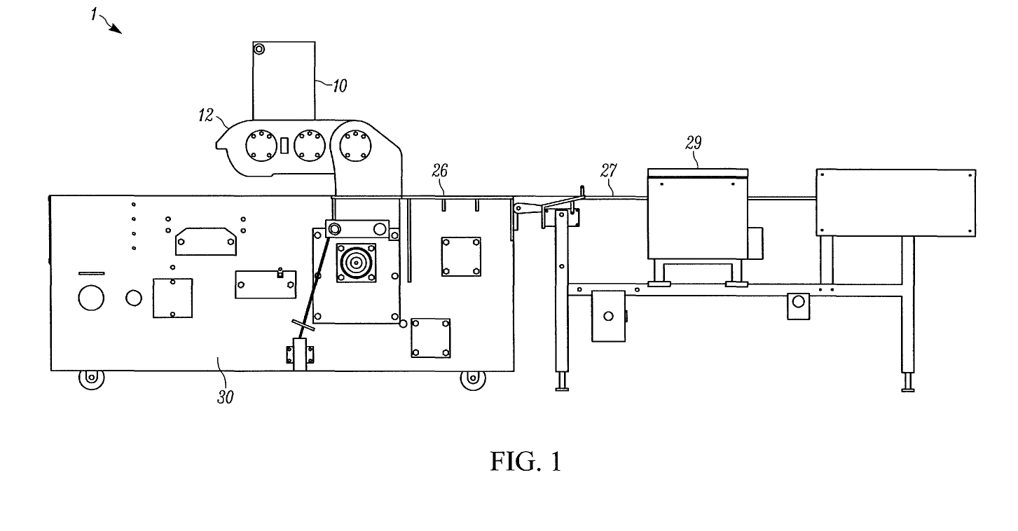

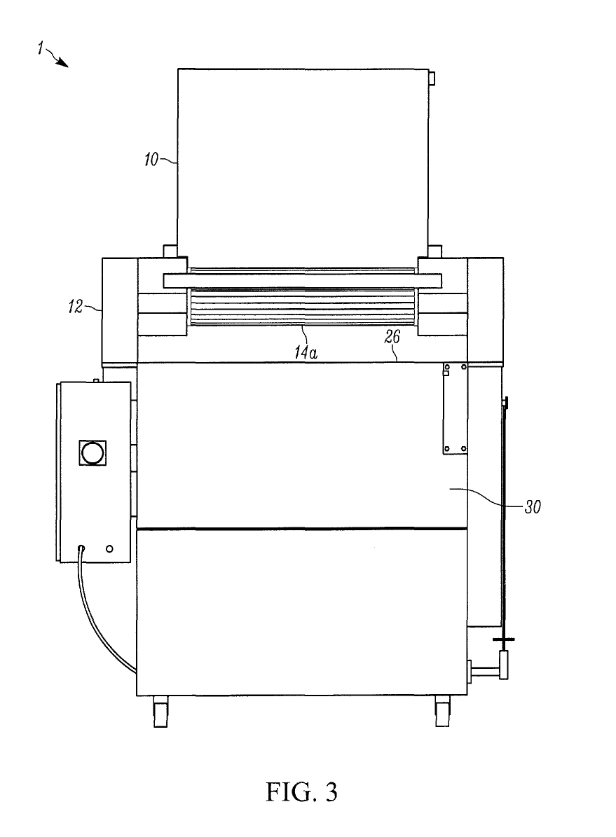

With reference to FIGS. 1 to 6, an extruder 1 is disclosed. The general design of the extruder is disclosed in FIGS. 1 to 6. At the top of extruder 1 is a hopper 10. Hopper 10 is designed to accept food ingredients to be processed in the extruder and feed the food ingredients, via gravity, to the other sections of the extrusion apparatus for processing. Additionally, a press 11 [not shown] may be utilized in conjunction with hopper 10 to aid the movement of the food ingredients from the hopper to the other sections of the extrusion apparatus for processing.

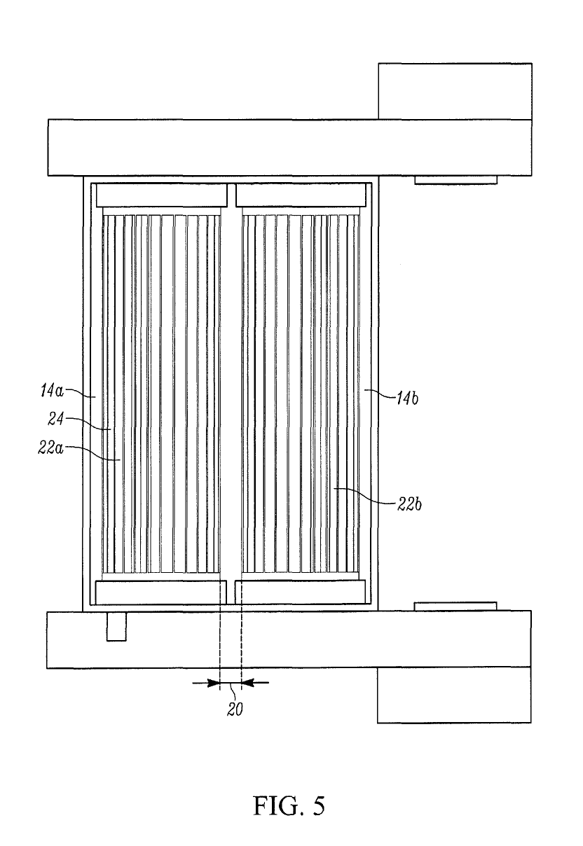

The hopper 10 may be any shape that promotes gravity feeding and, as such, may be rectangular, cylindrical, conical, a frustum, etc. In one preferred embodiment, best shown in FIGS. 1 and 5, hopper 10 is of a rectangular shape having dimensions 24 and ⅝ inches by 13 and 1/14 inches by 18 and ¼ inches, defining an opening of 24 inches by 12 and ½ inches.

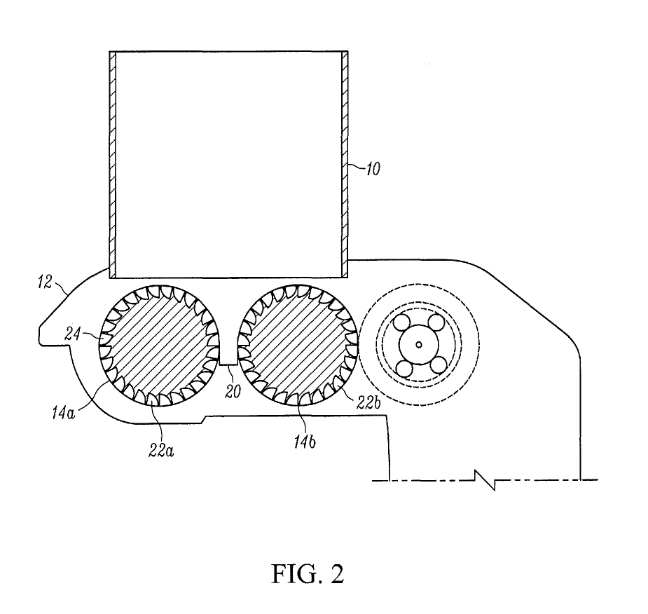

Hopper 10 is in fluid communication with, and is situated directly above, housing 12. Housing 12 receives the food ingredients and contains machinery to process the food ingredients. As such, housing 12 may be any shape which can accommodate both the machinery and the food ingredients. In one embodiment, as shown in FIGS. 1 and 2, housing 12 is generally of a hexagonal shape and has dimensions 35 inches by 32 inches by 10 and ½ inches.

As shown in FIGS. 2 and 5, located within housing 12 are feed rollers 14a and 14b. Feed rollers 14a and 14b process the food ingredients received from hopper 10 and form the ingredients into a thin sheet. Feed rollers 14a and 14b are rotatably mounted within housing 12 by way of axles 16a and 16b [not shown]. Feed rollers 14a and 14b are actuated by a belt/chain drive 18 [not shown].

Feed rollers 14a and 14b are preferably cylindrical, however other geometries that can be rotatably mounted may also be utilized. The dimensions of feed rollers 14a and 14b can vary. In one embodiment, as shown in FIGS. 2 and 5, feed rollers 14a and 14b are cylindrical and have a length of 24 inches and a diameter of 9 inches. Feed rollers 14 a and 14 b are oriented in the housing 12 such that a gap 20 of approximately ¼ inch to ⅜ inch (as shown in FIGS. 2 and 5) exists between the feed rollers.

Feed rollers 14a and 14b may be coated with a non-stick coating 24. Non-stick coating 24 prevents the food ingredients from adhering to feed rollers 14a and 14b and thus prevents obstructions of gap 20. Non-stick coating 24 includes, but is not limited to Teflon®, polytetrafluoroethylene, or other appropriate non-stick coatings.

As shown in FIG. 5, feed rollers 14a and 14b contain grooves 22a and 22b, respectively, which run longitudinally along feed rollers 14a and 14b. Grooves 22a and 22b, along with non-stick coating 24, prevent food ingredients from adhering to feed rollers 14a and 14b. Grooves 22a and 22b further aid in guiding the food ingredients through gap 20.

In a preferred embodiment, grooves 22a and 22b are designed such that the ratio of the diameter of the feed rollers to the depth of grooves is 72:1, and the ratio of the diameter of the feed rollers to the width of the groove is 12:1. As such, where feed rollers 14a and 14b have a 9 inch diameter, grooves 22a and 22b will have a depth of ⅛ inch and a width of ¾ inch.

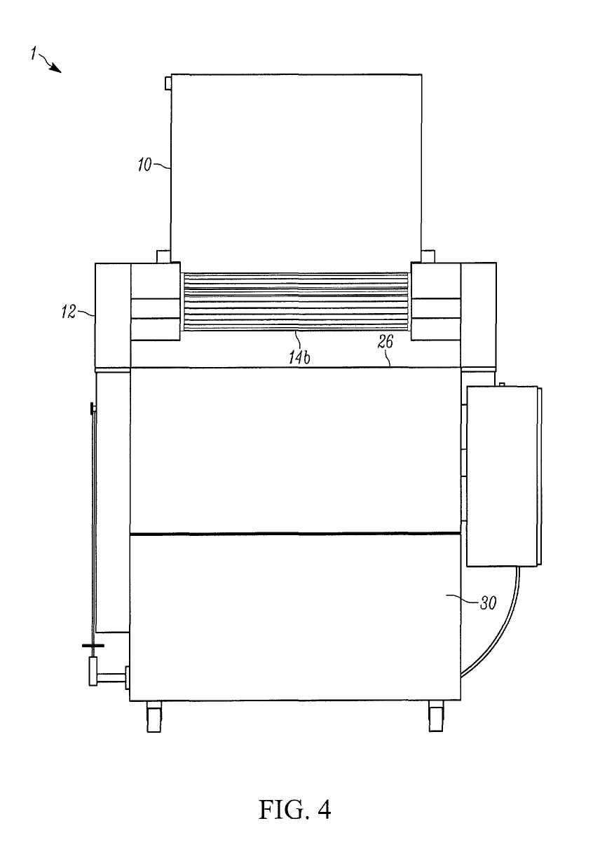

As shown in FIGS. 1 and 4, situated directly below and in fluid communication with housing 12 is conveyor 26. Conveyor 26 receives the processed food product from housing 12 and transfers the food product away from the extruder 1 for further processing and/or packaging. In one embodiment, conveyor 26 is a conveyor belt having dimensions 84 inches by 28 inches, and is actuated by a belt drive 28 [not shown]. Additionally, conveyor 26 may be linked to other conveyors for further processing and or analysis. As shown in FIG. 1, conveyor 26 may be linked to a second conveyor segment 27 having dimensions of 84 inches long by 28 inches, which in turn supports a metal detector 29. Metal detector 29 alerts the user as to the presence of metal fragments in the product. In a preferred embodiment, conveyor 26 is further connected to a cooling conveyor 31 [not shown], having dimensions 480 inches by 28 inches, which allows the product to further air cool.

Hopper 10, housing 12 and conveyor 26 are all supported by a base 30. Base 30 may be any shape which can accommodate the hopper 10, housing 12 and conveyor 26. In a preferred embodiment, base 30 is cuboid shaped and has dimensions 80 inches by 35 and ½ inches by 39 and ½ inches.

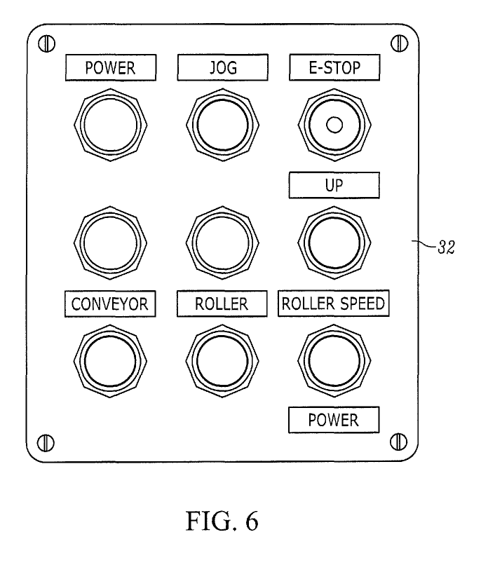

A controller 32, an embodiment of which is disclosed in FIG. 6, is in communication with conveyor actuation means and feed roller actuation means. Controller 32 may take the form of a control box, computer, control pad or other control devices and may be either wired or wireless. Controller 32 controls the rotational speed of feed rollers 14a and 14b, as well as the speed of conveyor 26. Controller 32 may also control other features of extruder 1 consistent with conventional extruders.

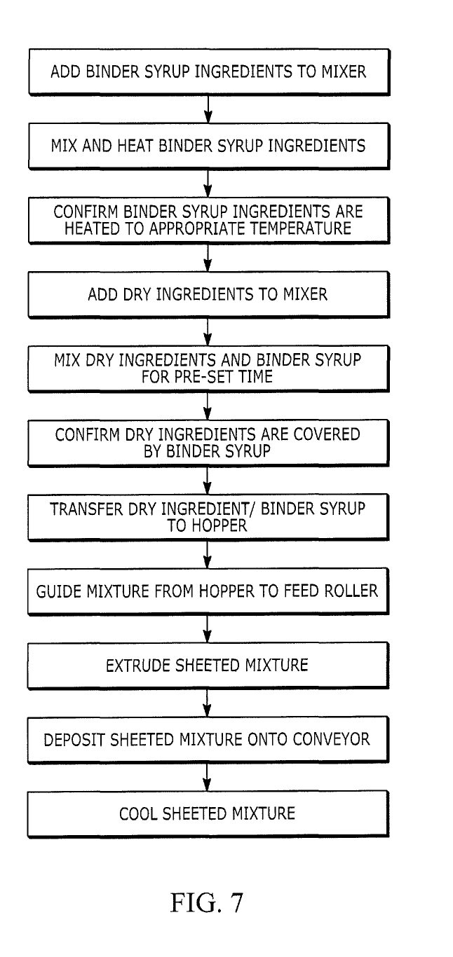

Referring to FIG. 7, a method in accordance with the claimed invention is disclosed. Specifically, FIG. 7 discloses a binding agent prepared by mixing ingredients in a heated container [not shown]. The binding agent is mixed until it reaches a desired temperature. In a preferred embodiment, the temperature is determined via a non-contact digital infrared thermometer. Once the mixed binding agent has reached the appropriate temperature, a dry ingredient not soluble in the binding agent is added to the container (which continues to be heated), and the dry ingredient and binding agent are mixed for a set period of time, forming a mixture. The mixture is inspected to confirm the binding agent has covered the majority of the surface area of the dry ingredient. In a preferred embodiment, the dry ingredient and binding agent are mixed for approximately three minutes and coverage of the dry ingredient by the binder agent is determined through visual inspection.

Once the dry ingredient is adequately covered by the binding agent, the mixture is removed from the heated container and immediately deposited in hopper 10, such that there is no significant cooling of the mixture. In a preferred embodiment, the transfer of the mixture from the heated container to hopper 10 is completed in less than 60 seconds. Hopper 10 guides the mixture via gravity to housing 12, where the mixture is contacted with feed rollers 14a and 14b. Additionally the mixture may also be guided by press 11. Grooves 22a and 22b of feed rollers 14a and 14b aid in the communication of the mixture through gap 20, forming a sheeted product.

Where the mixture has adhesive characteristics, the combination of grooves 22a, 22b and non-stick coating 24 prevent accumulation of the mixture on the feed rollers 14a and 14b, thus allowing the mixture to proceed through gap 20 unobstructed. Because of this, gap 20 may be smaller than gaps found in conventional extruders, allowing the claimed extruder 1 to produce a sheeted product that has a thickness of less than ½ inch, and preferably between ¼ inch and ⅜ inch.

Having passed through feed rollers 14a, 14b and gap 20, the mixture is deposited onto conveyor 26 as a sheeted product. Conveyor 26 transports the sheeted product away from hopper 10 and housing 12. The sheeted product cools and further solidifies as it progresses along the conveyor 26.

### WORKING EXAMPLES

A mixture is prepared from the ingredients set forth in Table 1:

TABLE 1

| Ingredient | Wt. % |
|---|---|
| Popcorn | 27% (unpopped) |
| Butter | 18% |
| Corn Syrup | 23% |
| White Sugar | 18% |
| Brown Sugar | 14% |
| Dried fruits | 0% |
| Nuts | 0% |
| Salt | >0.5% |

Alternatively, a mixture is prepared from the ingredients set forth in Table 2:

TABLE 2

| Ingredient | Wt. % |
|---|---|
| Popcorn | 26% (unpopped) |
| Butter | 17% |
| Corn Syrup | 21% |
| White Sugar | 17% |
| Brown Sugar | 13% |
| Dried fruits | 6% |
| Nuts | 0% |
| Salt | >0.5% |

Alternatively, a mixture is prepared from the ingredients set forth in Table 3:

TABLE 3

| Ingredient | Wt. % |
|---|---|
| Popcorn | 24% (unpopped) |
| Butter | 16% |
| Corn Syrup | 20% |
| White Sugar | 16% |
| Brown Sugar | 12% |
| Dried fruits | 6% |
| Nuts | 5% |
| Salt | >0.5% |

Alternatively, a mixture may be prepared from the general ranges for the ingredients set forth in Table 4:

TABLE 4

| Ingredient | Wt. % |
|---|---|
| Binder syrup | 65%-75% |
| Grain | 24%-30% |
| Flavoring Ingredient | 0.1%-11% |

The dried fruits referenced in Tables 1 to 3 include, but are not limited to, dried cherries and dried cranberries. The nuts referenced in Tables 1 to 3 include, but are not limited to pumpkin seeds, peanuts and almonds. Additionally, the popped popcorn referenced in Tables 1 to 3 can vary in size, type or shape, and can include popcorn that is first coated in cheese.

The butter, corn syrup, white sugar, brown sugar and salt are first blended together in an open flame copper kettle while the temperature of the mixture is monitored using a non-contact infrared thermometer. Once the mixture reaches between 292° F. and 295° F., the popcorn and any dried fruits or nuts are added to the mixture. The mixture is then blended for another two to three minutes, during which time the mixture is visually inspected to confirm that the popcorn, dried fruits and nuts are adequately covered by the remaining ingredients of the mixture.

Once the blending is complete, the mixture is immediately transferred to an extruder and poured into the extruder's hopper. Preferably, the transfer of the mixture from the kettle to the hopper is completed in under 60 seconds. The hopper gravity feeds the popcorn-containing mixture through the feed rollers of the extruder. Additionally, a press may be utilized to force the mixture through the hopper. Due to the combination of the grooves of the feed rollers, the feed rollers' non-stick coating and the size of the gap between the feed rollers, a thin sheet of mixture, less than ½ inch thick, is extruded onto the conveyor.

The thin sheet of mixture cools and solidifies as it progresses through the conveyor. The thins sheet of mixture is subsequently broken into pieces and packaged at the end of the conveyor.

Although the present invention has been described by reference to its preferred embodiment as is disclosed in the specification and drawings above, many more embodiments of the present invention are possible without departing from the invention. Thus, the scope of the invention should be limited only by the appended claims.

1. A method of preparing a sheeted mixture comprising a binding agent and a dry ingredient, the method comprising the steps of:
heating said binding agent;
mixing said dry ingredient with said binding agent to form a mixture;
transferring said mixture to an extruder, wherein said extruder comprises feed rollers coated with a non-stick coating;
extruding a sheet comprising said mixture; and
cooling said sheet comprising said mixture;
wherein said sheet comprising said mixture has a thickness of less than ½ inch.

2. The method of claim 1, wherein said sheet comprising said mixture has a thickness between ¼ inch and ⅜ inch.

3. The method of claim 1, wherein said non-stick coating comprises Teflon®.

4. The method of claim 1, wherein said feed rollers comprise a comprise a first feed roller and a second feed roller, and wherein said first feed roller and said second feed roller are oriented in said housing such that a gap of approximately ¼ inch to ⅜ inch exists between said first feed roller and said second feed roller.

5. The method of claim 4, wherein said first feed roller and said second feed roller are cylindrical and have longitudinally oriented grooves.

6. The method of claim 5, wherein the ratio of the diameter of said first feed roller or said second feed roller to the depth of said longitudinally oriented grooves is 72:1 and wherein the ratio of the diameter of said first feed roller or said second feed roller to the depth of said longitudinally oriented grooves is 12:1.

7. The method of claim 6, wherein said first feed roller and said second feed roller have a diameter of 9 inches and a length of 24 inches.

8. The method of claim 1, wherein said transferring said mixture to an extruder step is completed in less than 60 seconds.

9. The method of claim 1, wherein said mixing said dry ingredient with said binding agent to form a mixture step further includes confirming that said binding agent has covered the majority of the surface area of said dry ingredient.

10. The method of claim 1, wherein said dry ingredient comprises a grain and a flavoring ingredient and wherein said grain comprises 24-30 wt. % of said mixture, said flavoring ingredient comprises 0.1-11 wt. % of said mixture and said binding agent comprises 65-75 wt. % of said mixture.

11. The method of claim 10, wherein said binding agent comprises butter, corn syrup, white sugar, brown sugar and salt, said dry ingredient comprises popcorn and said flavoring ingredient comprises dried cherries, dried cranberries, pumpkin seeds, peanuts or almonds, and mixtures thereof.

12. The method of claim 11, wherein said popcorn is cheese coated.

13. An apparatus for extruding material comprising:
a hopper;
a housing containing feed rollers, said housing being in fluid communication with said hopper, wherein the exterior of said feed rollers are coated with a non-stick coating;
a conveyor in fluid communication with said housing;
means to actuate said feed rollers and said conveyor; and
means to control the rate of movement of said feed rollers and said conveyor;
wherein said feed rollers comprise a first feed roller and a second feed roller, wherein said first feed roller and said second feed roller are oriented in said housing such that a gap of approximately ¼ inch to ⅜ inch exists between said first feed roller and said second feed roller.

14. The apparatus of claim 13, wherein said non-stick coating comprises Teflon®.

15. The apparatus of claim 13, wherein said conveyor is a conveyor belt.

16. The apparatus of claim 13, wherein said first feed roller and said second feed roller are cylinders and said first feed roller and said second feed roller have longitudinally oriented grooves.

17. The apparatus of claim 16, wherein the ratio of the diameter of said first feed roller or said second feed roller to the depth of said longitudinally oriented grooves is 72:1 and wherein the diameter of said first feed roller or said second feed roller to the depth of said longitudinally oriented grooves is 12:1.

18. The apparatus of claim 17, wherein said first feed roller and said second feed roller have a diameter of 9 inches and a length of 24 inches.

19. A composition comprising a sheeted mixture of grain, flavoring ingredient and binding agent, wherein said grain comprises 24-30 wt. % of said sheeted mixture, said flavoring ingredient comprises 0.1-11 wt. % of said mixture and said binding agent comprises 65-75 wt. % of said sheeted mixture.

20. The composition of claim 19, wherein said binding agent comprises butter, corn syrup, white sugar, brown sugar and salt, said dry ingredient comprises popcorn and said flavoring ingredient comprises dried cherries, dried cranberries, pumpkin seeds, peanuts or almonds, and mixtures thereof.

21. The composition of claim 20, wherein said popcorn is cheese coated.
